(19) United States
(12) Patent Application Publication
(10) Pub. No.: US 2009/0033302 A1
(43) Pub. Date: Feb. 5, 2009

(54) Voltage conversion device

(75) Inventor: Daisuke Hariu, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/920,157

(22) PCT Filed: Jun. 5, 2006
(86) PCT No.: PCT/JP2006/311684

§ 371 Date: Nov. 9, 2007

(30) Foreign Application Priority Data
Jun. 17, 2005 (JP) 2005-177423

(51) Int. Cl. G05F 1/618

(52) U.S. Cl. 323/283

(57) ABSTRACT

When a voltage conversion operation is started, a control circuit (30) performs an operation to obtain a voltage command value for each control timing with setting a target voltage obtained based on a torque command value (TR) and a motor rotation number (MRN) as a final value, and controls a boost converter (12) so as to match an output voltage (Vm) with the voltage command value. The control circuit (30) has a prescribed threshold value set to be lower than the target voltage. The control circuit (30) controls the boost converter (12) with setting an absolute value of a rate of change between control timings to a first value until the voltage command value reaches the prescribed threshold value. When the voltage command value becomes at least the prescribed threshold value, the boost converter (12) is controlled with setting the absolute value of the rate of change to a second value smaller than the first value.

### TECHNICAL FIELD

The present invention relates to a voltage conversion device converting a DC voltage from a power supply into a target voltage.

### BACKGROUND ART

In recent years, hybrid vehicles and electric vehicles are receiving attention as ecologically friendly vehicles. A hybrid vehicle uses, besides a conventional engine, a DC power supply, an inverter and a motor driven by the inverter as a mechanical power source. That is, the hybrid vehicle obtains mechanical power by driving the engine and also by converting a DC voltage from the DC power supply into an AC voltage with the inverter and rotating the motor with the AC voltage converted.

An electric vehicle uses a DC power supply, an inverter and a motor driven by the inverter as a mechanical power source.

In the hybrid vehicle or the electric vehicle as described above, a construction has been considered in which a DC voltage from a DC power supply is boosted with a boost converter and a boosted DC voltage is supplied to an inverter driving a motor (for example, see Japanese Patent Laying-Open No. 2003-259689, Japanese Patent Laying-Open No. 10-127094 and Japanese Patent Laying-Open No. 2002-112572).

Japanese Patent Laying-Open No. 2003-259689 discloses a control circuit of a chopper circuit including a voltage rate circuit setting a rate to a voltage command during a boost operation in light of suppressing overshooting of an output voltage of the chopper circuit boosting or stepping down a DC voltage from a DC power supply to a desired DC voltage.

According to this publication, when a voltage command is increased from a start time of boosting in a boost operation, the voltage rate circuit sets a rate to the voltage command so as to keep a difference between the output voltage of the chopper circuit and the voltage command within a predetermined range.

In detail, the voltage rate circuit increases the voltage command at a constant rate from a main circuit capacitor voltage as an initial value. In this situation, when a difference between a detected value of the output voltage of the chopper circuit (a voltage detection value) and the voltage command becomes larger than the predetermined range, the voltage rate circuit temporarily stops increasing of the voltage command. Then, when the difference between the voltage detection value and the voltage command returns to the predetermined range, the voltage command is again increased at the constant rate.

In a method of controlling a converter circuit disclosed in Japanese Patent Laying-Open No. 2003-259689, however, the rate for increasing the voltage command is subjected to feedback control based on a difference between the voltage detection value obtained by detection of the output voltage of the chopper circuit and the voltage command. Therefore, when the voltage command abruptly changes in response to a sudden variation in a load, a control response capability sufficient to handle such change cannot be maintained. In this situation, overshooting of the output voltage of the chopper circuit may occur due to a delay in the control response capability.

Furthermore, the predetermined range as a criterion of the voltage rate circuit for making a determination to temporarily stop application of the rate is set to a prescribed voltage range having the voltage command as a median value. Therefore, when the voltage detection value becomes higher than the voltage command by a value larger than the predetermined range, that is, when overshooting of the output voltage of the chopper circuit occurs, the voltage rate circuit stops increasing of the voltage command after detecting the overshooting. Therefore, overshooting cannot be reliably prevented.

Furthermore, since the voltage rate circuit controls the rate based on the voltage detection value, a period of time taken until the output voltage of the chopper circuit reaches a desired DC voltage varies depending on magnitude of the voltage detection value. Therefore, management of a response period of motor control may not be possible.

Therefore, an object of the present invention is to provide a voltage conversion device which has a good control response capability and can suppress overshooting of an output voltage.

### DISCLOSURE OF THE INVENTION

According to the present invention, a voltage conversion device includes a voltage converter converting a DC voltage between a power supply and a drive circuit driving a load, and a control circuit controlling the voltage converter so as to match an output voltage of the voltage converter with a target voltage determined with a required output of the load. The control circuit includes a voltage command operation portion performing an operation to obtain a voltage command value with setting the target voltage as a final value, and a voltage conversion control portion controlling the voltage converter so as to match the output voltage with the voltage command value obtained for each control timing. The voltage command operation portion can vary a rate of change of the voltage command value corresponding to magnitude of the voltage command value in a present control timing.

According to the present invention, since the rate of change is set corresponding to the magnitude of the voltage command value, a high control response capability can be attained as compared to a conventional control circuit in which a rate of change is set based on an output voltage of a voltage converter. In addition, since a tracking capability of the output voltage of the voltage converter for the voltage command value is ensured, overshooting of the output voltage can be suppressed.

The voltage conversion device preferably further includes a capacity element arranged between the voltage converter and the drive circuit for smoothing the DC voltage converted and inputting a resulting voltage into the drive circuit.

Therefore, according to the present invention, since the capacity element can be protected from overshooting of the output voltage, a margin is not required to be provided to a rated voltage of the capacity element, and a capacity of the capacity element can be decreased.

The voltage command operation portion preferably has a prescribed threshold value set to be lower than the target voltage. The voltage command operation portion performs an operation to obtain the voltage command value with setting an absolute value of the rate of change to a first value until the voltage command value reaches the threshold value, and performs an operation to obtain the voltage command value with setting the absolute value of the rate of change to a second value lower than the first value when the voltage command value becomes at least the threshold value.

Therefore, according to the present invention, since the rate of change is decreased in response to the voltage command value going beyond the threshold value, overshooting of the output voltage can be suppressed by ensuring the tracking capability of the output voltage of the voltage converter for the voltage command value, and a response period of the load can be prevented from delaying.

The prescribed threshold value is preferably lower than a maximum voltage allowed to be input to the load.

Therefore, according to the present invention, the load can be protected from an overvoltage due to overshooting of the output voltage.

According to the present invention, since the rate of change of the voltage command value between control timings is set corresponding to the magnitude of the voltage command value, a high control response capability can be attained as compared to the conventional control circuit in which a rate of change of a voltage command value is controlled using an output voltage of a voltage converter. Therefore, the tracking capability of the output voltage of the voltage converter for the voltage command value can be ensured until the output voltage reaches the target voltage, and thus overshooting of the output voltage can be suppressed.

Furthermore, since a period required for the output voltage to reach the target voltage can be accurately determined, a response period to the load can be managed and a high response capability for the load can be maintained.

### BRIEF DESCRIPTION OF THE DRAWINGS

FIG. 1 is a schematic block diagram of a motor drive device to which a voltage conversion device according to an embodiment of the present invention is applied.

FIG. 2 is a functional block diagram of a control device shown in FIG. 1.

FIG. 3 is a functional block diagram of an inverter control circuit shown in FIG. 2.

FIG. 4 is a functional block diagram of a converter control circuit shown in FIG. 2.

FIG. 5 shows output waveforms of a voltage command value Vdc_stp, an output voltage Vm and a DC voltage Vb obtained by application of a conventional converter control circuit.

FIG. 6 is a schematic diagram for describing a setting operation for voltage command value Vdc_stp according to the present invention.

FIG. 7 shows output waveforms of voltage command value Vdc_stp, output voltage Vm and DC voltage Vb obtained by application of the converter control circuit according to the present invention.

FIG. 8 is a flow chart for describing operations for controlling a boost converter shown in FIG. 1.

FIG. 9 is a flow chart for describing a detailed operation in step S02 shown in FIG. 8.

### BEST MODES FOR CARRYING OUT THE INVENTION

An embodiment of the present invention will now be described in detail referring to the drawings. It is to be noted that, the same characters in the drawings Indicate the same or corresponding portions.

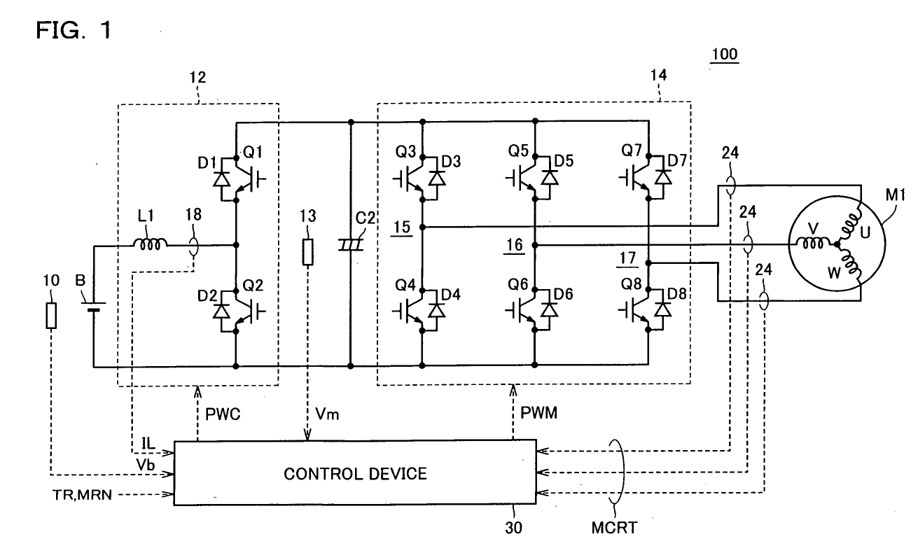

FIG. 1 is a schematic block diagram of a motor drive device to which a voltage conversion device according to the embodiment of the present invention is applied.

Referring to FIG. 1, a motor drive device 100 includes a DC power supply B, voltage sensors 10, 13, current sensors 18, 24, a capacitor C2, a boost converter 12, an inverter 14, and a control device 30.

An AC motor M1 is a drive motor for generating a torque for driving a driving wheel of a hybrid vehicle or an electric vehicle. AC motor M1 also has a function of a generator driven by an engine, and can operate as an electric motor for the engine to perform, for example, starting of the engine.

Boost converter 12 includes a reactor L1, NPN transistors Q1, Q2 and diodes D1, D2.

Reactor L1 has one end connected to a power supply line of DC power supply B and the other end connected to an intermediate point between NPN transistor Q1 and NPN transistor Q2, that is, a point between an emitter of NPN transistor Q1 and a collector of NPN transistor Q2.

NPN transistors Q1, Q2 are connected in series between the power supply line and an earth line. A collector of NPN transistor Q1 is connected to the power supply line, and an emitter of NPN transistor Q2 is connected to the earth line. In addition, diodes D1, D2 for flowing currents from an emitter side to a collector side are respectively connected between collectors and emitters of NPN transistors Q1, Q2.

Inverter 14 is formed with a U phase arm 15, a V phase arm 16 and a W phase arm 17. U phase arm 15, V phase arm 16 and W phase arm 17 are provided in parallel with each other between the power supply line and the earth line.

U phase arm 15 is formed with NPN transistors Q3, Q4 connected in series. V phase arm 16 is formed with NPN transistors Q5, Q6 connected in series. W phase arm 17 is formed with NPN transistors Q7, Q8 connected in series. In addition, diodes D3-D8 for flowing currents from the emitter side to the collector side are respectively connected between collectors and emitters of NPN transistors Q3-Q8.

An intermediate point of each phase arm is connected to each phase end of each phase coil of AC motor M1. That is, AC motor M1 is a permanent magnet motor of three phases formed with three coils of U, V and W phases having respective one ends connected in common at a median point. The other end of a U phase coil is connected to an intermediate point between NPN transistors Q3, Q4, the other end of a V phase coil is connected to an intermediate point between NPN transistors Q5, Q6, and the other end of a W phase coil is connected to an intermediate point between NPN transistors Q7, Q8.

DC power supply B is formed with a secondary battery such as a nickel metal hydride battery or a lithium-ion battery. Voltage sensor 10 detects a voltage Vb output from DC power supply B, and outputs detected voltage Vb to control device 30.

Boost converter 12 boosts a DC voltage supplied from DC power supply B and supplies the result to capacitor C2. More specifically, boost converter 12 receives a signal PWC from control device 30, boosts the DC voltage according to a period of turning-on of NPN transistor Q2 with signal PWC, and supplies the result to capacitor C2.

In addition, when boost converter 12 receives signal PWC from control device 30, boost converter 12 steps down a DC voltage supplied from inverter 14 via capacitor C2 and supplies the result to DC power supply B.

Capacitor C2 smoothes a DC voltage output from boost converter 12 and supplies a smoothed DC voltage to inverter 14.

Voltage sensor 13 detects a voltage Vm between both ends of capacitor C2 (corresponding to an input voltage of inverter 14, which is the same in the following), and outputs detected voltage Vm to control device 30.

When the DC voltage is supplied from capacitor C2, inverter 14 converts the DC voltage into an AC voltage based on a signal PWM from control device 30 to drive AC motor M1. With this, AC motor M1 is driven to generate a torque specified with a torque command value TR.

In addition, during regenerative braking of the hybrid vehicle or electric vehicle having motor drive device 100 mounted thereon, inverter 14 converts an AC voltage generated by AC motor M1 into a DC voltage based on signal PWM from control device 30, and supplies a converted DC voltage to boost converter 12 via capacitor C2.

It is to be noted that, the “regenerative braking” used herein includes breaking involving regeneration when a foot brake operation is performed by a driver of the hybrid vehicle or electric vehicle, or deceleration (or stopping of acceleration) of the vehicle with regeneration by turning-off of an accelerator pedal during driving rather than by the operation of the foot brake.

Current sensor 18 detects a reactor current IL flowing through reactor L1, and outputs detected reactor current IL to control device 30.

Current sensor 24 detects a motor current MCRT flowing through AC motor M1 and outputs detected motor current MCRT to control device 30.

Control device 30 receives torque command value TR and a motor rotation number MRN from an ECU (Electrical Control Unit) which is provided externally, voltage Vm from voltage sensor 13, reactor current IL from current sensor 18, and motor current MCRT from current sensor 24. Control device 30 generates signal PWM for switching control of NPN transistors Q3-Q8 of inverter 14 during driving of AC motor M1 by inverter 14 based on voltage Vm, torque command value TR and motor current MCRT by a method described below, and outputs generated signal PWM to inverter 14.

In addition, when inverter 14 drives AC motor MI, control device 30 generates signal PWC for switching control of NPN transistors Q1, Q2 of boost converter 12 based on voltages Vb, Vm, torque command value TR and motor rotation number MRN by a method described below, and outputs generated signal PWC to boost converter 12.

Furthermore, during regenerative braking of the hybrid vehicle or electric vehicle having motor drive device 100 mounted thereon, control device 30 generates signal PWM for converting the AC voltage generated by AC motor M1 into a DC voltage based on voltage Vm, torque command value TR and motor current MCRT, and outputs generated signal PWM to inverter 14. In this situation, NPN transistors Q3-Q8 of inverter 14 are subjected to switching control with signal PWM. With this, inverter 14 converts the AC voltage generated by AC motor M1 into a DC voltage and supplies the DC voltage to boost converter 12.

During the regenerative braking, control device 30 further generates signal PWC for stepping down the DC voltage supplied from inverter 14 based on voltages Vb, Vm, torque command value TR and motor rotation number MRN, and outputs generated signal PWC to boost converter 12. With this, the AC voltage generated by AC motor M1 is converted into a DC voltage, stepped down, and then supplied to DC power supply B.

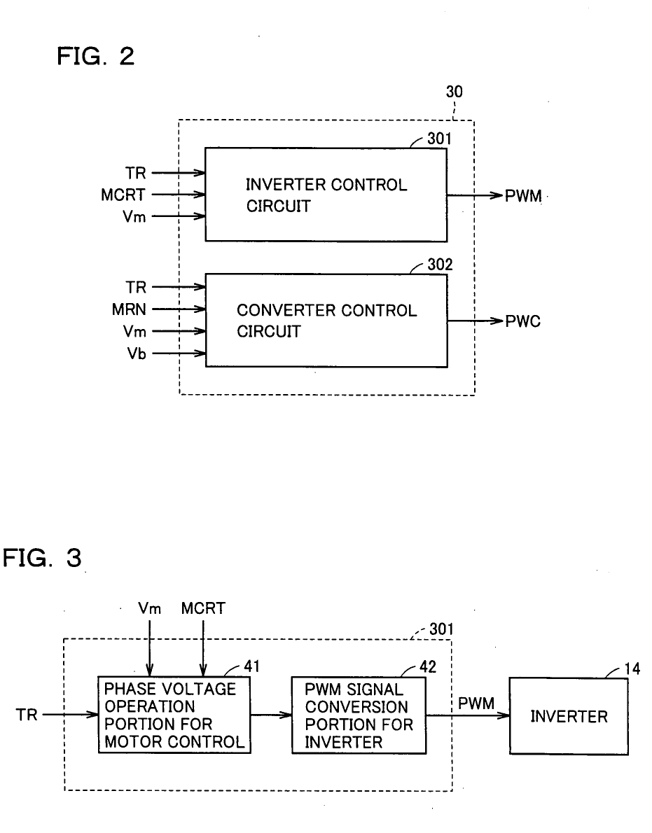

FIG. 2 is a functional block diagram of control device 30 shown in FIG. 1.

Referring to FIG. 2, control device 30 includes an inverter control circuit 301 and a converter control circuit 302.

Inverter control circuit 301 generates signal PWM for turning on/off NPN transistors Q3-Q8 of inverter 14 during driving of AC motor M1 based on torque command value TR, motor current MCRT and voltage Vm, and outputs generated signal PWM to inverter 14.

In addition, during regenerative braking of the hybrid vehicle or electric vehicle having motor drive device 100 mounted thereon, inverter control circuit 301 generates signal PWM for converting the AC voltage generated by AC motor M1 into a DC voltage based on torque command value TR, motor current MCRT and voltage Vm, and outputs the signal to inverter 14.

Converter control circuit 302 generates signal PWC for turning on/off NPN transistors Q1, Q2 of boost converter 12 during driving of AC motor M1 based on torque command value TR, voltages Vb, Vm and motor rotation number MRN, and outputs generated signal PWC to boost converter 12.

In addition, during regenerative braking of the hybrid vehicle or electric vehicle having motor drive device 100 mounted thereon, converter control circuit 302 generates signal PWC for stepping down the DC voltage from inverter 14 based on torque command value TR, voltages Vb, Vm and motor rotation number MRN, and outputs generated signal PWC to boost converter 12.

As described above, boost converter 12 has a function of a bidirectional converter since boost converter 12 can also decrease a voltage with signal PWC for stepping down the DC voltage.

FIG. 3 is a functional block diagram of inverter control circuit 301 shown in FIG. 2.

Referring to FIG. 3, inverter control circuit 301 includes a phase voltage operation portion for motor control 41 and a PWM signal conversion portion for an inverter 42.

Phase voltage operation portion for motor control 41 receives from voltage sensor 13 output voltage Vm of boost converter 12, that is, an input voltage to inverter 14, receives motor current MCRT flowing through each phase of AC motor M1 from current sensor 24, and receives torque command value TR from the external ECU. Phase voltage operation portion for motor control 41 calculates a voltage to be applied to the coil of each phase of AC motor M1 based on torque command value TR, motor current MCRT and voltage Vm, and outputs a result of calculation to PWM signal conversion portion for inverter 42.

PWM signal conversion portion for inverter 42 generates signal PWM for actually turning on/off NPN transistors Q3-Q8 of inverter 14 based on the result of calculation received from phase voltage operation portion for motor control 41, and outputs generated signal PWM to each of NPN transistors Q3-Q8 of inverter 14.

With this, each of NPN transistors Q3-Q8 of inverter 14 is subjected to switching control and controls a current flowing through each phase of AC motor M1 to allow AC motor M1 to output a specified torque. Motor current MCRT is controlled as such, and a motor torque corresponding to torque command value TR is output.

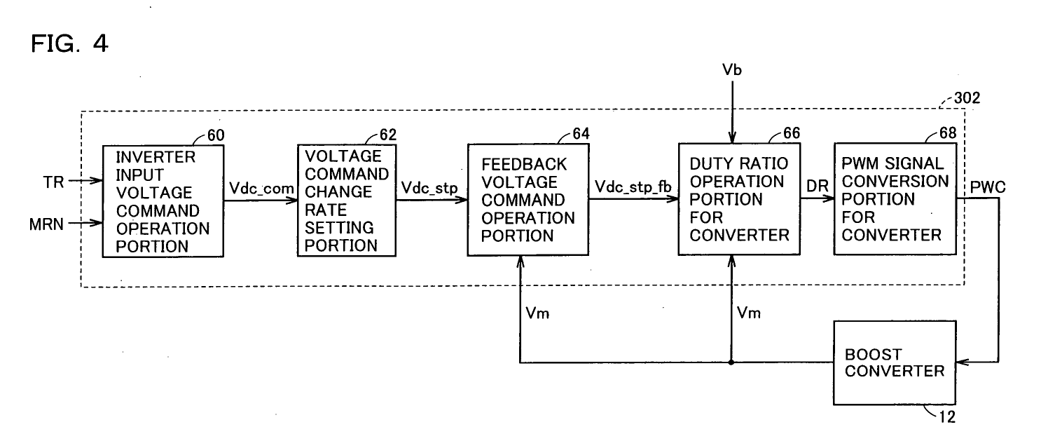

FIG. 4 is a functional block diagram of converter control circuit 302 shown in FIG. 2.

Referring to FIG. 4, converter control circuit 302 includes an inverter input voltage command operation portion 60, a voltage command change rate setting portion 62, a feedback voltage command operation portion 64, a duty ratio operation portion for a converter 66, and a PWM signal conversion portion for a converter 68.

Inverter input voltage command operation portion 60 performs an operation to obtain an optimum value (target value) of the input voltage of inverter 14, that is, a target voltage Vdc_com of boost converter 12 based on torque command value TR and motor rotation number MRN from the external ECU. Inverter input voltage command operation portion 60 then outputs obtained target voltage Vdc_com to voltage command change rate setting portion 62.

When target voltage Vdc_com is received from inverter input voltage command operation portion 60, voltage command change rate setting portion 62 sets a rate of change (which means a rate of increase or a rate of decrease, which is the same in the following) of a voltage command value Vdc_stp between control timings by a method described below.

The “control timing” used herein means a timing in synchronization with a control cycle of converter control circuit 302. It is to be noted that, the “control cycle” corresponds to a period required for converter control circuit 302 to set output voltage Vm to voltage command value Vdc_stp. That is, voltage command value Vdc_stp gradually varies (increases or decreases, which is the same in the following) for each control timing with setting target voltage Vdc_com of boost converter 12 as a final value.

Then, voltage command change rate setting portion 62 performs an operation to obtain voltage command value Vdc_stp in each control timing according to a set rate of change, and outputs obtained voltage command value Vdc_stp to feedback voltage command operation portion 64.

Feedback voltage command operation portion 64 receives output voltage Vm of boost converter 12 from voltage sensor 13 and voltage command value Vdc_stp from voltage command change rate setting portion 62. Feedback voltage command operation portion 64 then performs an operation to obtain a feedback voltage command value Vdc_stp_fb for setting output voltage Vm to voltage command value Vdc_stp based on a deviation of output voltage Vm from voltage command value Vdc_stp, and outputs obtained feedback voltage command value Vdc_stp_fb to duty ratio operation portion for converter 66.

Duty ratio operation portion for converter 66 receives DC voltage Vb from voltage sensor 10 and output voltage Vm from voltage sensor 13. Duty ratio operation portion for converter 66 performs an operation to obtain a duty ratio DR for setting output voltage Vm to feedback voltage command value Vdc_stp_fb based on DC voltage Vb, output voltage Vm and feedback voltage command value Vdc_stp_fb, and generates signal PWC for turning on/off NPN transistors Q1, Q2 of boost converter 12 based on obtained duty ratio DR. Then, duty ratio operation portion for converter 66 outputs generated signal PWC to NPN transistors Q1, Q2 of boost converter 12.

With this, boost converter 12 converts DC voltage Vb into output voltage Vm so as to set output voltage Vm to voltage command value Vdc_stp. Feedback voltage command operation portion 64 and duty ratio operation portion for converter 66 repeat a series of control as described above based on voltage command value Vdc_stp gradually increasing or decreasing for each control timing until output voltage Vm becomes target voltage Vdc_com.

In controlling of boost converter 12 as described above, converter control circuit 302 according to the present invention is characterized in that the rate of change of voltage command value Vdc_stp between control timings is set based on magnitude of voltage command value Vdc_stp in a present control timing.

Accordingly, the rate of change of voltage command value Vdc_stp becomes a variable value which can be varied corresponding to magnitude of voltage command value Vdc_stp for each control timing. Then, converter control circuit 302 controls boost converter 12 to allow output voltage Vm to track voltage command value Vdc_stp varying at the variable rate of change.

Therefore, converter control circuit 302 according to the present invention is different from a conventional voltage rate circuit described above in that a detected value of output voltage Vm is not considered in setting of the rate of change for varying voltage command value Vdc_stp. With this difference, converter control circuit 302 according to the present invention attains a high control response capability, as described below. As a result, overshooting of output voltage Vm can be avoided, and capacitor C2 and inverter 14 can be protected from an overload.

A setting operation for the rate of change of voltage command value Vdc_stp performed by voltage command change rate setting portion 62 shown in FIG. 4 will now be described in detail.

For a purpose of comparison, a variation in output voltage Vm is first considered in a situation of application of a conventional converter control circuit which controls a rate of change of voltage command value Vdc_stp based on a detected value of output voltage Vm. In the following description, the voltage rate circuit of Japanese Patent Laying-Open No. 2003-259689 described above is adopted as the conventional converter control circuit.

With adopting the voltage rate circuit of Japanese Patent Laying-Open No. 2003-259689, the rate of change of voltage command value Vdc_stp is set based on a difference between the detected value of output voltage Vm and voltage command value Vdc_stp. More specifically, when the difference between output voltage Vm and voltage command value Vdc_stp is larger than a predetermined range, the rate of change of voltage command value Vdc_stp is temporarily set to zero. Then, when the difference between output voltage Vm and voltage command value Vdc_stp returns to the predetermined range, the rate of change is set to a predetermined value again.

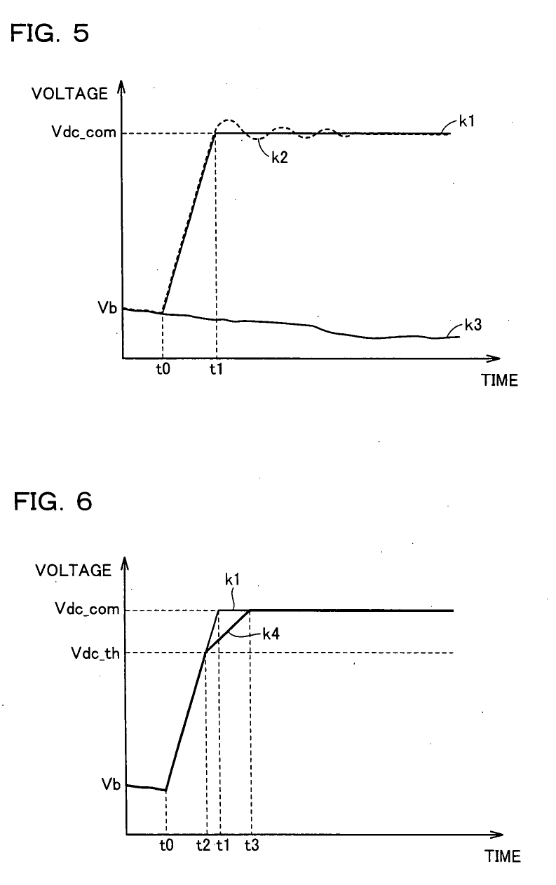

FIG. 5 shows output waveforms of voltage command value Vdc_stp, output voltage Vm and DC voltage Vb obtained by application of the conventional converter control circuit.

Referring to FIG. 5, when torque command value TR is received from the external ECU during driving of AC motor M1, the conventional converter control circuit starts a voltage conversion operation to match output voltage Vm with target voltage Vdc_com in a timing of a time t=t0.

In this situation, the voltage rate circuit increases voltage command value Vdc_stp at a constant rate of change (corresponding to an inclination of a waveform k1 between times t0 and t1) based on the difference between voltage command value Vdc_stp indicated with waveform k1 and output voltage Vm indicated with a waveform k2 being within the predetermined range. Then, when the difference between voltage command value Vdc stp and output voltage Vm goes beyond the predetermined range, the voltage rate circuit temporarily sets the rate of change to zero until the difference returns to the predetermined range.

As output voltage Vm increases to a value near target voltage Vdc_com, however, output voltage Vm in the voltage rate circuit sometimes cannot track voltage command value Vdc_stp and overshooting may occur in waveform k2.

One of causes of occurrence of overshooting of output voltage Vm is a delay in a control response capability which occurs because the voltage rate circuit detects output voltage Vm and sets the rate of change of voltage command value Vdc_stp to the predetermined value or zero. In addition, in the situation shown in FIG. 5, the voltage rate circuit sets the rate of change to zero when output voltage Vm becomes higher than voltage command value Vdc_stp by a value higher than the predetermined range, that is, when occurrence of overshooting of output voltage Vm is detected, which makes it difficult to prevent the overshooting.

Such overshooting of output voltage Vm causes a breakdown of control of AC motor M1 and also puts an excessive burden to capacitor C2 and inverter 14. In particular, when target voltage Vdc com is approximately a maximum voltage Vmax in motor drive device 100 (corresponding to a maximum voltage allowed to be input considering a circuit construction), output voltage Vm going beyond rated voltages of circuit elements such as capacitor C2 and inverter 14 damages the elements. In a motor drive device, a circuit element as capacitor C2 or inverter 14 is generally formed with a part having a relatively high rated voltage to include a margin in a withstand voltage property thereof considering such overshooting of output voltage Vm. This results in an increased size of the motor drive device and an increased cost.

Therefore, converter control circuit 302 according to the present invention has a construction allowing the rate of change of voltage command value Vdc_stp to be variable corresponding to magnitude of voltage command value Vdc_stp in a present control timing to suppress overshooting of output voltage Vm. That is, output voltage Vm is not considered in setting of voltage command value Vdc_stp.

FIG. 6 is a schematic diagram for describing a setting operation for voltage command value Vdc_stp according to the present invention.

Referring to FIG. 6, when target voltage Vdc_com is received from inverter input voltage command operation portion 60, voltage command change rate setting portion 62 of converter control circuit 302 sets a prescribed voltage lower than target voltage Vdc_com as a threshold value Vdc_th. Then, voltage command change rate setting portion 62 sets the rate of change of voltage command value Vdc_stp between control timings to vary voltage command value Vdc_stp according to a waveform k4.

More specifically, when a voltage conversion operation starts at time t=t0, voltage command change rate setting portion 62 varies voltage command value Vdc_stp with setting an absolute value of the rate of change to a prescribed value R1 (corresponding to an inclination of waveform k4 between times t0 and t2). When voltage command value Vdc_stp reaches threshold value Vdc_th at time t2, the absolute value of the rate of change is changed to a value R2 (corresponding to an inclination of waveform k4 between times t2 and t3) which is smaller than prescribed value R1. With this, in a period until voltage command value Vdc_stp matches target voltage Vdc_com at time t3, voltage command value Vdc_stp varies at a rate of change R2 which is lower than a rate of change R1 in a previous period.

Rate of change R1 of voltage command value Vdc_stp is set based on a control cycle of converter control circuit 302 so as to prevent occurrence of a delay of a response time to a load. In addition, rate of change R2 is set to a value which ensures a tracking capability of output voltage Vm for voltage command value Vdc_stp. Each of rates of change R1, R2 is set based on a processing speed of converter control circuit 302, a switching speed of NPN transistors Q1, Q2 of boost converter 12, a variation speed of torque command value TR, and the like, and is stored beforehand in voltage command change rate setting portion 62.

In addition, the absolute value of the rate of change between times t0 and t2 shown in FIG. 6 may be varied to at most a value of rate of change R1 corresponding to voltage command value Vdc_stp. Furthermore, the absolute value of the rate of change between times t2 and t3 may be varied to at most a value of rate of change R2 corresponding to voltage command value Vdc_stp.

In addition, threshold value Vdc_th is desirably set to a voltage near target voltage Vdc_com and to be lower than target voltage Vdc_com, as shown in FIG. 6. This is for attaining both of suppression of overshooting of output voltage Vm and decrease in the response period of the motor control.

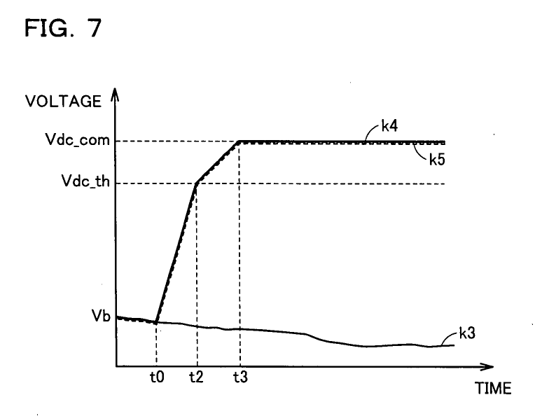

FIG. 7 shows output waveforms of voltage command value Vdc_stp, output voltage Vm and DC voltage Vb obtained by application of the converter control circuit according to the present invention.

Referring to FIG. 7, as shown with waveform k4, voltage command value Vdc_stp increases from voltage Vb as an initial value at rate of change R1, and then increases at lower rate of change R2 when voltage command value Vdc_stp becomes higher than threshold value Vth below target voltage Vdc_com. As shown with a waveform k5, output voltage Vm is controlled to track this increase of voltage command value Vdc_stp and reaches target voltage Vdc_com without overshooting.

According to the present invention, since output voltage Vm is stably controlled until output voltage Vm reaches target voltage Vdc_com, capacitor C2 and inverter 14 as loads can be protected from an overvoltage. Therefore, the load which was conventionally formed with a part having a relatively high rated voltage considering the overvoltage can be formed with a small and inexpensive part having a lower rated voltage. As a result, size reduction and cost reduction of the motor drive device can be attained.

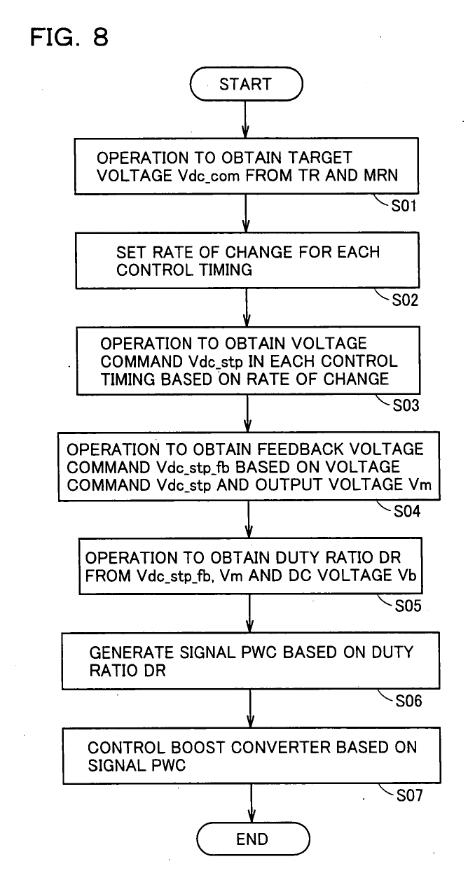

FIG. 8 is a flow chart for describing operations for controlling boost converter 12 shown in FIG. 1.

Referring to FIG. 8, when a series of operations is started, inverter input voltage command operation portion 60 performs an operation to obtain the target value (target voltage Vdc_com) of the input voltage of inverter 14 based on torque command value TR and motor rotation number MRN from the external ECU (step S01). Inverter input voltage command operation portion 60 then outputs obtained target voltage Vdc_com to voltage command change rate setting portion 62.

When target voltage Vdc_com is received, voltage command change rate setting portion 62 sets the rate of change of voltage command value Vdc_stp, which can be varied for each control timing, with setting target voltage Vdc_com as a final value (step S02). Voltage command change rate setting portion 62 then performs an operation to obtain voltage command value Vdc_stp in each control timing based on a set rate of change (step S03). Voltage command change rate setting portion 62 outputs obtained voltage command value Vdc_stp to feedback voltage command operation portion 64.

When feedback voltage command operation portion 64 receives output voltage Vm of boost converter 12 from voltage sensor 13 and voltage command value Vdc_stp from voltage command change rate setting portion 62, feedback voltage command operation portion 64 performs an operation to obtain feedback voltage command value Vdc_stp_fb for setting output voltage Vm to voltage command value Vdc_stp based on a deviation of output voltage Vm from voltage command value Vdc_stp, and outputs obtained feedback voltage command value Vdc_stp_fb to duty ratio operation portion for converter 66 (step S04).

Duty ratio operation portion for converter 66 further receives DC voltage Vb from voltage sensor 10 and output voltage Vm from voltage sensor 13. Duty ratio operation portion for converter 66 performs an operation to obtain duty ratio DR for setting output voltage Vm to feedback voltage command value Vdc_stp_fb based on DC voltage Vb, output voltage Vm and feedback voltage command value Vdc_stp fb (step S05).

PWM signal conversion portion for converter 68 generates signal PWC for turning on/off NPN transistors Q1, Q2 of boost converter 12 based on obtained duty ratio DR, and outputs generated signal PWC to NPN transistors Q1, Q2 of boost converter 12 (step S06).

With this, boost converter 12 converts DC voltage Vb into output voltage Vm so as to set output voltage Vm to voltage command value Vdc_stp. Feedback voltage command operation portion 64 and duty ratio operation portion for converter 66 repeat a series of control as described above based on voltage command value Vdc_stp gradually increasing or decreasing for each control timing until output voltage Vm becomes target voltage Vdc_com (step S07).

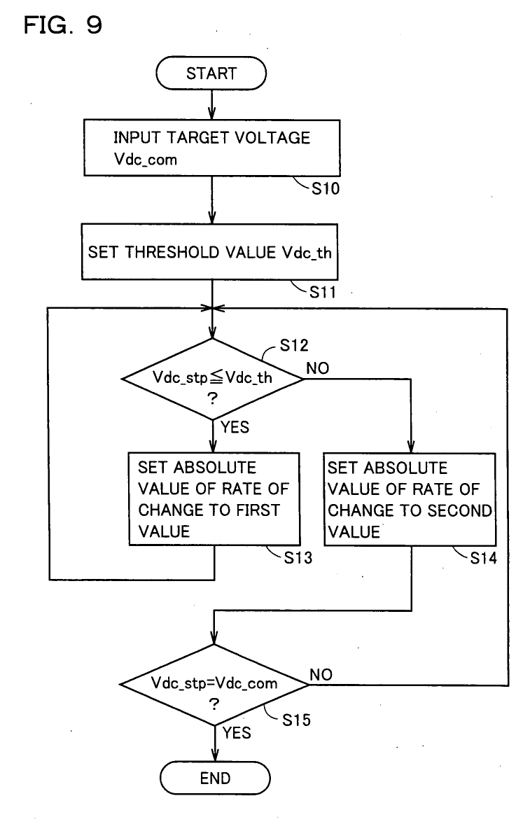

FIG. 9 is a flow chart for describing a detailed operation in step S02 shown in FIG. 8.

Referring to FIG. 9, voltage command change rate setting portion 62 receives target voltage Vdc_com from inverter input voltage command operation portion 60 (step S10), and sets threshold value Vdc_th to be lower than target voltage Vdc_com (step S11).

Then, voltage command change rate setting portion 62 determines as to whether voltage command value Vdc_stp in a present control timing is at most threshold value Vdc_th or not (step S12).

When it is determined that voltage command value Vdc_stp is at most threshold value Vdc_th in step S12, voltage command change rate setting portion 62 sets an absolute value of the rate of change to a first value R1 which is stored beforehand (step S13). Then, an operation is performed to obtain voltage command value Vdc_stp in a next control timing based on rate of change R1 set.

On the other hand, when it is determined that voltage command value Vdc_stp is higher than threshold value Vdc_th in step S12, voltage command change rate setting portion 62 sets the absolute value of the rate of change to a second value R2 which is smaller than first value R1 (step S14). Then, an operation is performed to obtain voltage command value Vdc_stp in the next control timing based on rate of change R2 set.

A series of operations indicated in steps S12-S14 is repeated for each control timing until voltage command value Vdc_stp reaches target voltage Vdc_com in step S15.

As described above, according to the embodiment of the present invention, since voltage command change rate setting portion 62 sets the rate of change based on voltage command value Vdc_stp in a present control timing, a high control response capability can be attained as compared to the conventional converter control circuit in which the rate of change is controlled based on a detected value of output voltage Vm. As a result, overshooting of output voltage Vm can be suppressed.

In addition, since output voltage Vm is stably controlled until output voltage Vm reaches target voltage Vdc_com, capacitor C2 and inverter 14 as loads can be protected from an overvoltage. Therefore, the load which was conventionally formed with a part having a relatively high rated voltage considering the overvoltage can be formed with a small and inexpensive part having a lower rated voltage. As a result, size reduction and cost reduction of the motor drive device can be attained.

Furthermore, since the rate of change is set based on voltage command value Vdc_stp, a period from a timing of start of the voltage conversion operation to a timing of output voltage Vm reaching target voltage Vdc_com can be determined more accurately as compared to the conventional converter control circuit in which the rate of change is set based on the detected value of output voltage Vm. As a result, a response period of motor control can be managed.

### INDUSTRIAL APPLICABILITY

The present invention can be applied to a motor drive device mounted on a vehicle.

1. A voltage conversion device, comprising:
a voltage converter converting a DC voltage between a power supply and a drive circuit driving a load; and
a control circuit controlling said voltage converter so as to match an output voltage of said voltage converter with a target voltage determined with a required output of said load; wherein
said control circuit includes
a voltage command operation portion performing an operation to obtain a voltage command value with setting said target voltage as a final value, and
a voltage conversion control portion controlling said voltage converter so as to match said output voltage with said voltage command value obtained for each control timing; and
said voltage command operation portion can vary a rate of change of said voltage command value corresponding to magnitude of said voltage command value in a present control timing.

2. The voltage conversion device according to claim 1, further comprising
a capacity element arranged between said voltage converter and said drive circuit for smoothing said DC voltage converted and inputting a resulting voltage into said drive circuit.

3. The voltage conversion device according to claim 2, wherein
said voltage command operation portion has a prescribed threshold value set to be lower than said target voltage, performs an operation to obtain said voltage command value with setting an absolute value of said rate of change to a first value until said voltage command value reaches said threshold value, and performs an operation to obtain said voltage command value with setting the absolute value of said rate of change to a second value lower than said first value when said voltage command value becomes at least said threshold value.

4. The voltage conversion device according to claim 3, wherein
said threshold value is lower than a maximum voltage allowed to be input to said load.

5. A voltage conversion device, comprising:
a voltage converter converting a DC voltage between a power supply and a drive circuit driving a load; and
a control circuit controlling said voltage converter so as to match an output voltage of said voltage converter with a target voltage determined with a required output of said load; wherein
said control circuit includes
voltage command operation means for performing an operation to obtain a voltage command value with setting said target voltage as a final value, and
voltage conversion control means for controlling said voltage converter so as to match said output voltage with said voltage command value obtained for each control timing; and
said voltage command operation means can vary a rate of change of said voltage command value corresponding to magnitude of said voltage command value in a present control timing.

6. The voltage conversion device according to claim 5, further comprising
a capacity element arranged between said voltage converter and said drive circuit for smoothing said DC voltage converted and inputting a resulting voltage into said drive circuit.

7. The voltage conversion device according to claim 6, wherein
said voltage command operation means has a prescribed threshold value set to be lower than said target voltage, performs an operation to obtain said voltage command value with setting an absolute value of said rate of change to a first value until said voltage command value reaches said threshold value, and performs an operation to obtain said voltage command value with setting the absolute value of said rate of change to a second value lower than said first value when said voltage command value becomes at least said threshold value.

8. The voltage conversion device according to claim 7, wherein
said threshold value is lower than a maximum voltage allowed to be input to said load.
